(19) United States
(12) Patent Application Publication
(10) Pub. No.: US 2012/0079460 A1
(43) Pub. Date: Mar. 29, 2012

(54) INSTRUMENTATION APPARATUS AND METHOD

(76) Inventors: Dae-Hyun CHO, Suwon-si (KR); Sun-Ae SEO, Seoul (KR); Sung-Do MOON, Seongnam-si (KR)

(21) Appl. No.: 13/171,796

(22) Filed: Jun. 29, 2011

(30) Foreign Application Priority Data
Sep. 27, 2010 (KR) 10-2010-0093456

(51) Int. Cl. G06F 9/44

(52) U.S. Cl. 717/130

(57) ABSTRACT

Provided is an instrumentation apparatus and method for inserting an instrumentation function into a program. The instrumentation function may be inserted into code that is outside of a loop of a program or a system library function relevant to the program.

### CROSS-REFERENCE TO RELATED APPLICATION(S)

This application claims the benefit under 35 U.S.C. §119(a) of Korean Patent Application No. 10-2010-0093456, filed on Sep. 27, 2010, in the Korean Intellectual Property Office, the entire disclosure of which is incorporated herein by reference for all purposes.

### BACKGROUND

1. Field

The following description relates to an instrumentation technology for verifying the performance of a program and for detecting errors in the program during the execution of the program.

2. Description of the Related Art

Instrumentation is a process of inserting additional code into a program to collect various information on the program during the execution of the program.

Along with the development of multi-core systems, a variety of multi-thread programs have been developed. Multi-thread programs are generally complicated and difficult to analyze for the tuning of their performance. Accordingly, instrumentation has attracted attention as a tool for observing the behavior of programs.

One of the main obstacles to instrumentation is overhead. For example, because there is additional code inserted into a program during the execution of the program and the additional code is executed along with the program, call overhead and execution overhead are inevitable.

### SUMMARY

In one general aspect, there is provided an instrumentation apparatus for inserting an instrumentation function into a program, the instrumentation apparatus including a loop analyzer configured to analyze a loop included in the program, and an inserter configured to insert an instrumentation function for observing the loop in the program at a position which is outside of the loop, based on the results of the analysis performed by the loop analyzer.

The loop analyzer may detect the loop from the program and determines whether the loop is a single-exit loop.

The loop analyzer may extract loop information of the loop, if the loop is determined to be a single-exit loop.

The loop information may include a number of iterations of the loop, information on one or more basic blocks of the loop, and information on a dominator of the loop.

The inserter may set one or more parameters of the instrumentation function based on the loop information, and may insert the instrumentation function in the program at a position which is outside of the loop to observe the basic blocks of the loop.

In another aspect, there is provided an instrumentation apparatus for inserting an instrumentation function into a program, the instrumentation apparatus including a table storage storing an instrumentation function table that comprises one or more instrumentation functions, wherein the instrumentation functions have the same semantics as the target function, and an inserter for inserting the instrumentation functions in the program at a position which is outside of the target function based on the instrumentation function table and the semantics of the target function.

The parameters of the instrumentation functions may be set based on the semantics of the target function.

The target function may include a system library function relevant to the program.

In another aspect, there is provided an instrumentation method for inserting an instrumentation function into a program, the instrumentation method including extracting a target object from the program, adjusting the parameters of an instrumentation function based on the semantics of the target object, and inserting the instrumentation function in the program at a position which is outside of the target object.

The target object may include at least one of a basic block of a loop and a system library function relevant to the program.

If the target object is a dominator basic block of a single-exit loop, the inserting of the instrumentation function may comprise inserting the instrumentation function into a starting point of the single-exit loop.

If the target object is a system library function relevant to the program, the inserting of the instrumentation function may comprise inserting the instrumentation function into a call site that calls the system library function.

In another aspect, there is provided an instrumentation apparatus for reducing overhead, the instrumentation apparatus including a loop analyzer for detecting a target loop code from source code, and for extracting loop information of the loop from the source code, and an inserter for inserting an instrumentation function at a point of the source code that is outside of the loop of the target loop code, wherein the instrumentation function is for observing the behavior of the target loop code.

The inserter may adjust the parameters of the instrumentation function such that the same results are obtained as those observations results that would be obtained if the instrumentation code were inserted into the loop of the target loop code.

The instrumentation apparatus may further comprise a table storage comprising instrumentation functions that have parameters that are set based on the attributes and the behavior of a various target loop codes.

The inserter may search the table storage for an instrumentation function for observing the behavior of the target loop code, based on semantics of the target loop code, and in response to finding an instrumentation function for observing the target loop, the inserter may insert the found instrumentation function into the point of the source code that is outside of the target loop code.

Other features and aspects may be apparent from the following detailed description, the drawings, and the claims.

### BRIEF DESCRIPTION OF THE DRAWINGS

FIG. 1 is a diagram illustrating an example of instrumentation apparatus.

FIG. 2 is a diagram illustrating another example of an instrumentation apparatus.

FIGS. 3A and 3B are diagrams illustrating examples of inserting an instrumentation function.

FIG. 4 is a diagram illustrating another example of an instrumentation apparatus.

FIG. 5 is a diagram illustrating an example of an instrumentation function table.

FIG. 6 is a diagram illustrating examples of an instrumentation function.

FIG. 7 is a diagram illustrating another example of an instrumentation apparatus.

FIG. 8 is a flowchart illustrating an example of an instrumentation method.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

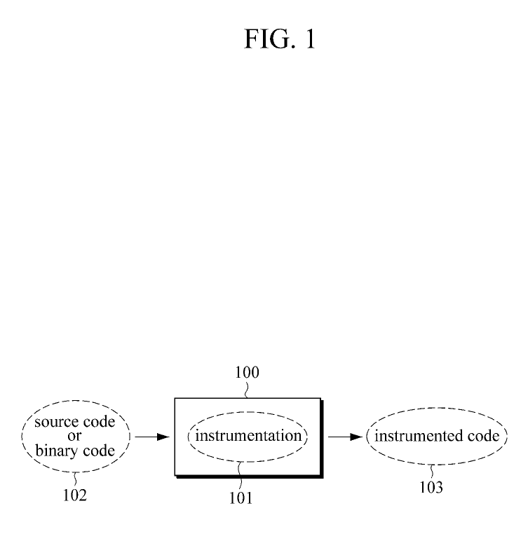

FIG. 1 illustrates an example of an instrumentation apparatus.

Referring to FIG. 1, instrumentation apparatus 100 may insert an instrumentation function 101 into a program. For example, the instrumentation function 101 may be additional code that may be inserted into a program before or during the execution of the program to collect various information on the program.

As another example, the instrumentation function 101 may also be referred to as instrumentation code or measurement code. The instrumentation apparatus 100 may insert the instrumentation function 101 into, for example, source code or binary code 102 of a program and may generate instrumented code 103.

In response to the instrumented code 103 being executed, information on the operation of the program into which the instrumentation function 101 is inserted may be collected by the instrumentation function 101. The collected information may vary based on the type of the instrumentation function 101. For example, multiple types of instrumentation functions 101 may be used for collecting multiple types of information. For example, a function for extracting memory access trace information, a function for counting the number of executions of a particular instruction, a function for detecting the behavior of a branch, and the like, may be used as the instrumentation function. It should be understood that the description is not restricted to these examples.

For example, the instrumentation function 101 may be inserted into a target loop or function, the instrumentation function 101 may be called whenever the target loop or function is executed. As a result, call overhead may be incurred. As another example, the instrumentation function 101 may be inserted in the outside of the target loop or function, and the instrumentation function 101 may be called less frequently than when inserted in the inside of the target loop or function. In this example, the instrumentation function 101 may be called only once when entering the target loop or function.

The instrumentation apparatus 100 may detect a target loop or function from the source or binary code 102. The instrumentation apparatus 100 may insert the instrumentation function 101 in the outside of the target loop or function. In this example, the instrumentation apparatus 100 may adjust or set one or more parameters of the instrumentation function 101 such that the same observation results may be obtained as those observation results that are obtainable when the instrumentation function 101 is inserted in the inside of the target loop or function.

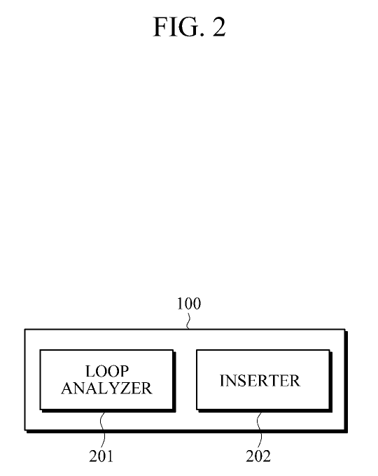

FIG. 2 illustrates another example of an instrumentation apparatus.

Referring to FIG. 2, the instrumentation apparatus 100 includes a loop analyzer 201 and an inserter 202.

The loop analyzer 201 may detect a target loop from a program to be observed. The loop analyzer 201 may determine whether the target loop is a single-exit loop. A single-exit loop is a loop in which execution completes when a particular condition in the corresponding loop is met. A multi-exit loop is a loop in which execution may be terminated in response to a break or goto instruction, regardless of whether a particular condition in the corresponding loop is met. Because the execution of a single-exit loop is terminated when a particular condition of the target loop is met, the number of iterations of the target loop can be estimated.

If the target loop is determined to be a single-exit loop, the loop analyzer 201 may extract loop information. For example, the loop information may include, but is not limited to, the number of iterations of the target loop, information on basic blocks of the target loop, information on the dominator of the target loop, and the like. The dominator of the target loop is one of the basic blocks in the target loop that needs to be executed.

The inserter 202 may insert the instrumentation function 101 in the outside of the target loop. For example, the inserter 202 may adjust the parameters of the instrumentation function 101 such that the same observation results are obtained as those observation results that are obtainable when the instrumentation function 101 is inserted in the inside of the target loop. The parameters of the instrumentation function 101 that are adjusted may be selected based on the loop information extracted by the loop analyzer 201.

A target object is an object of instrumentation. For example, a target object may be a basic block of a loop, a branch, a memory read/write operation, and the like. If the results of the analysis performed by the loop analyzer 201 indicate that the target object is the dominator basic block of the target loop or is included in the dominator basic block of the target loop, the inserter 202 may adjust the parameters of the instrumentation function 101, and may insert the instrumentation function 101 into the start point of the target loop.

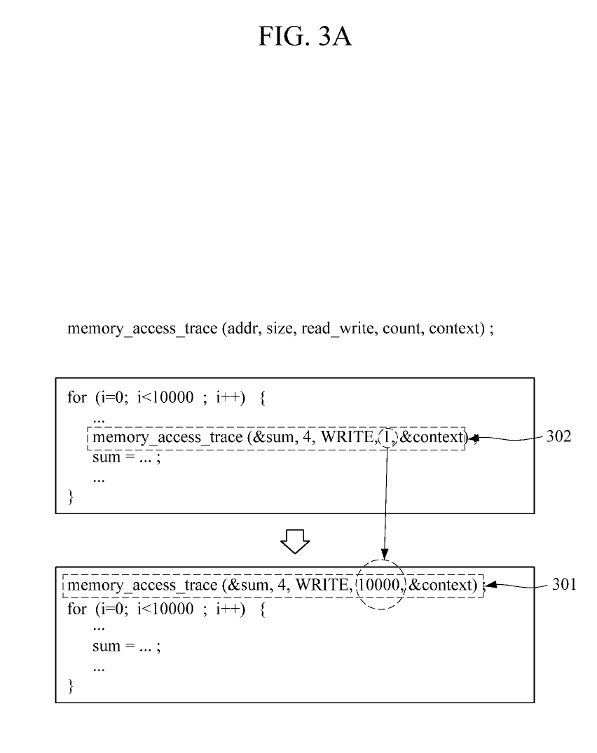

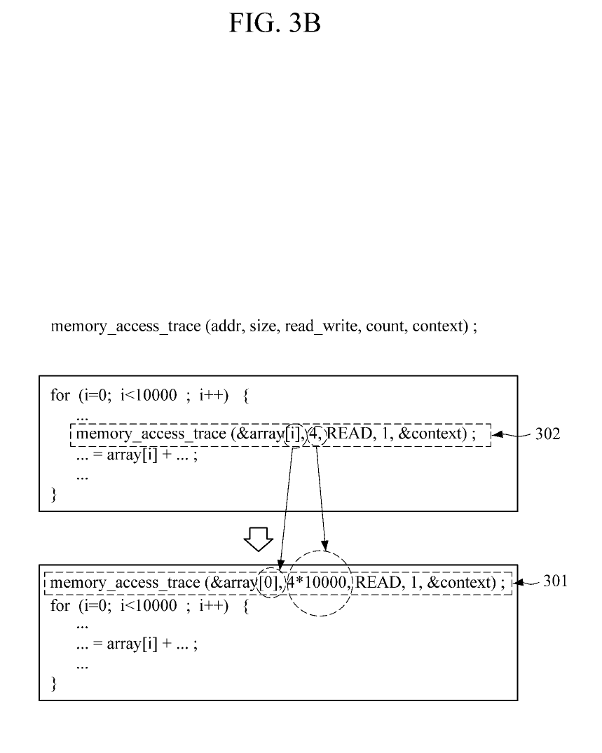

FIGS. 3A and 3B illustrate examples of inserting an instrumentation function. The instrumentation function may be, for example, a memory access trace function.

Referring to FIGS. 3A and 3B, the memory access trace function may be represented as follows: memory_access_trace(addr, size, read_write, count, context).

Referring to FIGS. 2, 3A, and 3B, the loop analyzer 201 may detect a target loop and may extract loop information of the target loop. For example, the inserter 202 may insert the memory access trace function in the outside of the target loop, which in this example is indicated by reference numeral 301. If the memory access trace function is inserted in the inside of the s target loop, which in this example is indicated by reference numeral 302, the memory access trace function may be called whenever the target loop is executed. As another example, if the memory access trace function is inserted in the outside of the target loop, the memory access trace function may be called only once.

For example, the inserter 202 may set the parameters of the memory access trace function based on the loop information extracted by the loop analyzer 201 such that the same observation results are obtained as those observation results that are obtainable when the memory access trace function is inserted in the inside of the target loop. For example, referring to FIG. 3A, if a memory access occurs to an address that never changes (i.e. invariable address) regardless of whether the target loop iterates, the value of a parameter count may be set equal to the number of iterations of the target loop. As another example, referring to FIG. 3B, if a memory access occurs to a address that changes (i.e. variable address) whenever the target loop iterates, the values of parameters addr and size may be adjusted.

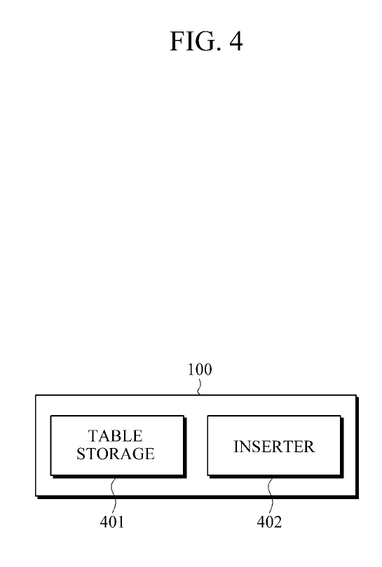

FIG. 4 illustrates another example of an instrumentation apparatus. Referring to FIG. 4, the instrumentation apparatus 100 includes a table storage 401 and an inserter 402.

The table storage 401 may store an instrumentation function table. For example, the instrumentation function table may store one or more instrumentation functions for each target function. The instrumentation functions stored in the instrumentation function table may have parameters that are set based on the attributes and behavior of a corresponding target function and may properly reflect the semantics of the corresponding target function. For example, the parameters of each instrumentation function stored in the instrumentation function table may be set such that the same observation results are obtained as those observation results that are obtainable when the corresponding instrumentation functions are inserted in the inside of their respective target functions.

The inserter 402 may search the instrumentation function table for one or more instrumentation functions that are suitable for a given target function, based on the semantics of the given target function. The inserter 402 may insert the returned instrumentation functions in the outside of the given target function.

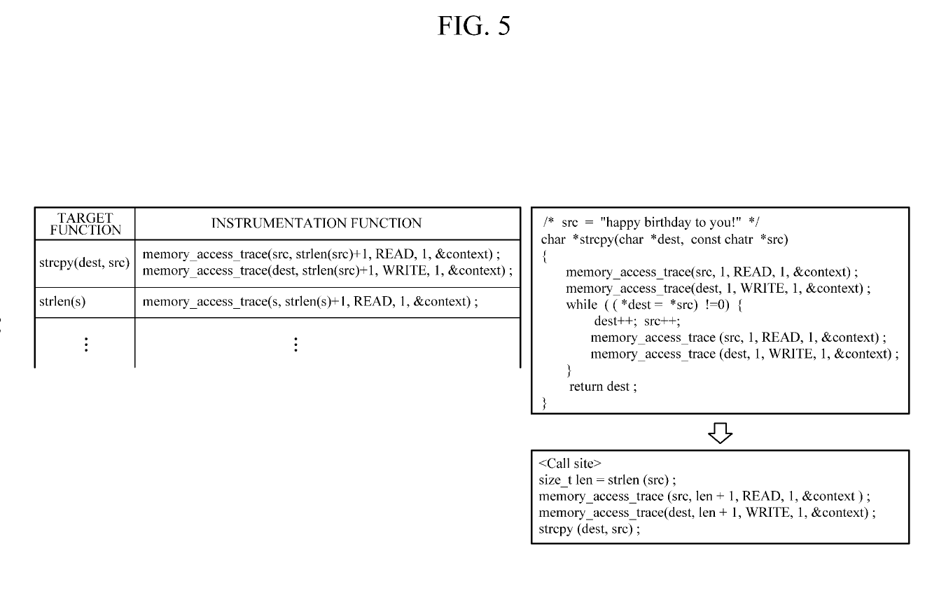

FIG. 5 illustrates an example of an instrumentation function table. The instrumentation function table illustrates an example of how to use an instrumentation function in connection with a memory access trace.

Referring to FIG. 5, the instrumentation function table may store a plurality of target functions and their respective instrumentation functions. For example, the target functions stored in the instrumentation function table may be well-known system library functions. For example, the instrumentation functions stored in the instrumentation function table may be memory access trace functions. The parameters of the memory access trace functions may be set such that desired observation results can be obtained even when the memory access trace functions are inserted in the outside of their respective target functions, or in call sites that call their respective target functions.

As an example, an instrumentation function is inserted in the inside of a function strcpy(dest, src) that is a function for copying a string that ends with ‘ [symbol] 0’ into a destination string dest. In this example, if a source string src is a 22-bits long string, for example, “happy birthday to you!,” the instrumentation function may be called 46 times (=(22+1)*2). However, if the parameters of the instrumentation function are adjusted such that bits are read from an address strlen(src)+1 that is apart from the address of the source string src and that the read bits are written on an address strlen(src)+1 that is apart from the address of the destination string dest, the number of times that the instrumentation function is called can be reduced from 46 times to 2 times.

Various functions such as strlen(s), strcat(dest, src), strcmp(s1, s2), memset(s, c, n), memcpy(dest, src, n), and the like may be listed in the instrumentation function table as target functions. As another example, a system library function having char* type or void* type as a parameter and a primitive function frequently called at the end of a call graph may be listed in the instrumentation function table as target functions.

Each entry in the instrumentation function table may record a target function and one or more instrumentation functions into which the semantics of the target function are reflected. For example, the instrumentation functions in each entry of the instrumentation function table may have parameters that are adjusted based on the semantics of a corresponding target function, which is further described herein.

For example, the parameters of an instrumentation function for a function such as strlen(s), which is a function for returning the length of a string s excluding a termination character ‘ [symbol] 0,’ may be set such that bits are read from an address strlen(s)+1 that is apart from the address of the string s.

As another example, the parameters of an instrumentation function for a function such as strcat(dest, src), which is a function for attaching a source string src to the end of a destination string dest, may be set such that bits are read from an address strlen(dest)+1 that is apart from the address of the destination string dest for locating the end of the destination string dest. In this example, bits may be read from an address strlen(src)+1 that is apart from the address of the source string src for searching for a string to be attached to the end of the destination string dest, and the bits read from the address strlen(src)+1 that is apart from the address of the source string src may be written on an address strlen(src)+1 that is apart from the address at the end of the destination string dest, i.e., dest+strlen(dest).

As another example, the parameters of an instrumentation function for a function such as strcmp(s1, s2), which a function for comparing strings s1 and s2 and determining whether the strings s1 and s2 are the same, may be set such that a number of bits corresponding to min(strlen(s1)+1, strlen(s2)+1) are read from the address of the string s1, and the number of bits corresponding to min(strlen(s1)+1, strlen(s2)+1) are read from the address of the string s2.

As another example, the parameters of an instrumentation function for a function such as memset(s, c, n), which is a function for filling up n vacant bits in the memory space pointed to by an address s with a character c, may be set such that n bits are read from the address s.

As another example, the parameters of an instrumentation function for a function memcpy(dest, src, n), which is a function for copying n bits in a source string src to a destination string dest, may be set such that n bits are read from the address of the source string src, and that n bits are written on the address of the destination string dest.

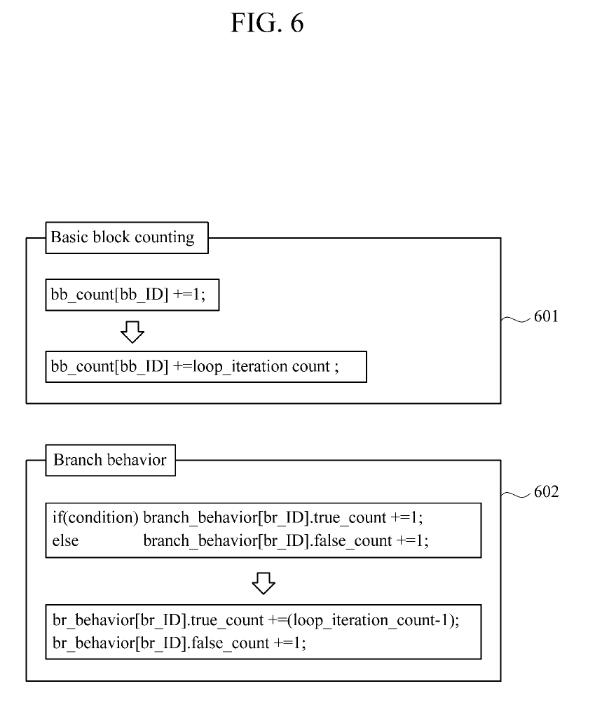

FIG. 6 illustrates examples of an instrumentation function. In this example, the instrumentation functions are for observing basic block counting and branch behavior.

Referring to FIG. 6, a basic block 601 may be a dominator basic block of a single-exit loop, and a branch 602 may be a branch for testing the exit of the single-exit loop.

In this example, instruction counting (basic block counting) may be observed by an instrumentation function that increases a basic block count value, for example, that increases a basic block count value each time the basic block 601 is executed. For example, the number of executions of the dominator of a loop may be calculated by an instrumentation function that increases the basic block count all at once to the number of iterations of the loop outside the loop.

The behavior of a branch may be observed by an instrumentation function that increases a true/false count value based on the condition of the branch each time a true or false value is returned. For example, the behavior of a branch for testing the exit of a loop may be calculated by an instrumentation function that increases the true/false count value all at once to the number of iterations of the loop outside the loop.

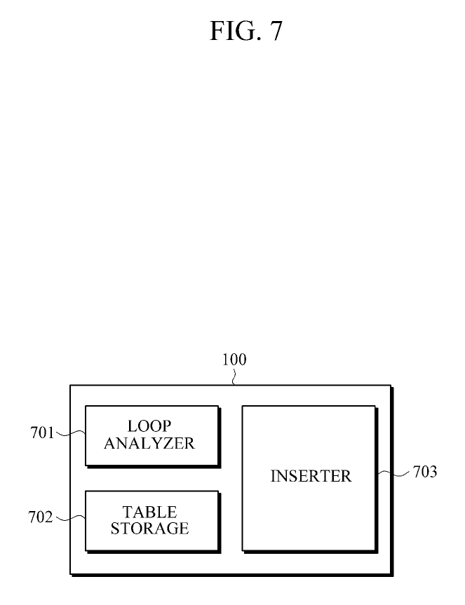

FIG. 7 illustrates another example of instrumentation apparatus.

Referring to FIG. 7, the instrumentation apparatus 100 includes a loop analyzer 701, a table storage 702, and an inserter 703.

The loop analyzer 701 may be the same as the loop analyzer 201 shown in FIG. 2, and the table storage 702 may be the same as the table storage 401 shown in FIG. 4.

If a target object is a loop, the inserter 703 may adjust the parameters of an instrumentation function based on loop information provided by the loop analyzer 701, and may insert the instrumentation function in the outside of the target loop. For example, if the target object is a function that has semantics that are already known, the inserter 703 may search an instrumentation function table stored in the table storage 702 for one or more instrumentation functions that are suitable for the target function, and may insert the returned instrumentation functions in the outside of the target function.

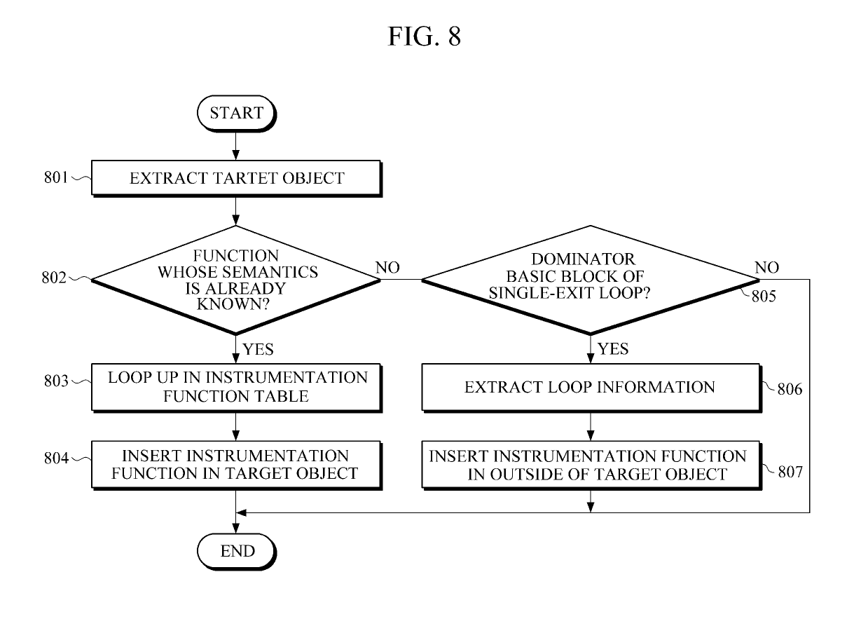

FIG. 8 illustrates an example of an instrumentation method.

Referring to FIGS. 7 and 8, a target object is extracted from a program to be observed, in 801. For example, the target object may be a portion of the program that is to be observed for a particular purpose.

Once the target object is extracted from the program, a determination is made as to whether the target object is a function that has semantics that are already known, in 802. For example, it may be determined whether the target object is a function listed in the instrumentation function table stored in the table storage 702.

If it is determined that the target object is a function that has semantics that are already known, one or more instrumentation functions corresponding to the function are looked up in the instrumentation function table stored in the table storage 702, in 803, and the returned instrumentation functions are inserted into the outside of the function, in 804.

On the other hand, if it is determined that the target object is not a function that has semantics that are already known, a determination is made as to whether the target object is a dominator basic block of a single-exit loop, in 805. In this example, if the target object is a dominator basic block of a single-exit loop or is located inside the dominator basic block of the single-exit loop, a predetermined instrumentation function may be inserted in the outside of the single-exit loop. For example, the loop analyzer 701 may determine whether a loop detected from the program is a single-exit loop and whether the target object is located inside a dominator basic block of the single-exit loop.

If the results of analysis performed by the loop analyzer 701 indicate that the target object is located in the dominator basic block of a single-exit loop, loop information on the single-exit loop is extracted, in 806. For example, the loop analyzer 701 may obtain various loop information for adjusting the parameters of the predetermined instrumentation function, such as the number of iterations of the single-exit loop. Once the loop information on the single-exit loop is extracted, the parameters of the predetermined instrumentation function are adjusted based on the extracted loop information. In 807, the predetermined instrumentation function is inserted in the outside of the single-exit loop.

If the target object is not a function that has semantics that are already known, and the target object is not a dominator basic block of a single-exit loop, the predetermined instrumentation function may be inserted in the inside of the target object.

As described above, because an instrumentation function or code may be inserted in the outside of a target object, instead of the inside of the target object, it is possible to prevent the instrumentation function or code from being called each time the target object is executed, and it is possible to reduce the number of times the instrumentation function or code is called, thus improving overall performance.

Although not shown in the drawings, the apparatuses described herein may include a controller for controlling the apparatus and the various components included in the apparatus. For example, the instrumentation apparatus may include a controller that controls one or more of the loop analyzer 201, the inserter 202, and the like.

As another example, the controller may be used to determine whether a target object is a function that has semantics already known, for example, a function that is already stored in the is table storage 702.

The methods, processes, functions, and software described herein may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules recorded, stored, or fixed in one or more computer-readable storage media, in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An instrumentation apparatus for inserting an instrumentation function into a program, the instrumentation apparatus comprising:
a loop analyzer configured to analyze a loop included in the program; and
an inserter configured to insert an instrumentation function for observing the loop in the program at a position which is outside of the loop, based on the results of the analysis performed by the loop analyzer.

2. The instrumentation apparatus of claim 1, wherein the loop analyzer detects the loop from the program and determines whether the loop is a single-exit loop.

3. The instrumentation apparatus of claim 2, wherein the loop analyzer extracts loop information of the loop, if the loop is determined to be a single-exit loop.

4. The instrumentation apparatus of claim 3, wherein the loop information includes a number of iterations of the loop, information on one or more basic blocks of the loop, and information on a dominator of the loop.

5. The instrumentation apparatus of claim 3, wherein the inserter sets one or more parameters of the instrumentation function based on the loop information, and inserts the instrumentation function in the program at a position which is outside of the loop to observe the basic blocks of the loop.

6. An instrumentation apparatus for inserting an instrumentation function into a program, the instrumentation apparatus comprising:
a table storage storing an instrumentation function table that comprises one or more instrumentation functions, wherein the instrumentation functions have the same semantics as the target function; and
an inserter for inserting the instrumentation functions in the program at a position which is outside of the target function based on the instrumentation function table and the semantics of the target function.

7. The instrumentation apparatus of claim 6, wherein the parameters of the instrumentation functions are set based on the semantics of the target function.

8. The instrumentation apparatus of claim 6, wherein the target function includes a system library function relevant to the program.

9. An instrumentation method for inserting an instrumentation function into a program, the instrumentation method comprising:
extracting a target object from the program;
adjusting the parameters of an instrumentation function based on the semantics of the target object; and
inserting the instrumentation function in the program at a position which is outside of the target object.

10. The instrumentation method of claim 9, wherein the target object includes at least one of a basic block of a loop and a system library function relevant to the program.

11. The instrumentation method of claim 10, wherein, if the target object is a dominator basic block of a single-exit loop, the inserting of the instrumentation function comprises inserting the instrumentation function into a starting point of the single-exit loop.

12. The instrumentation method of claim 10, wherein, if the target object is a system library function relevant to the program, the inserting of the instrumentation function comprises inserting the instrumentation function into a call site that calls the system library function.

13. An instrumentation apparatus for reducing overhead, the instrumentation apparatus comprising:
a loop analyzer for detecting a target loop code from source code, and for extracting loop information of the loop from the source code; and
an inserter for inserting an instrumentation function at a point of the source code that is outside of the loop of the target loop code,
wherein the instrumentation function is for observing the behavior of the target loop code.

14. The instrumentation apparatus of claim 13, wherein the inserter adjusts the parameters of the instrumentation function such that the same results are obtained as those observations results that would be obtained if the instrumentation code were inserted into the loop of the target loop code.

15. The instrumentation apparatus of claim 13, further comprising a table storage comprising instrumentation functions that have parameters that are set based on the attributes and the behavior of a various target loop codes.

16. The instrumentation apparatus of claim 15, wherein the inserter searches the table storage for an instrumentation function for observing the behavior of the target loop code, based on semantics of the target loop code, and in response to finding an instrumentation function for observing the target loop, the inserter inserts the found instrumentation function into the point of the source code that is outside of the target loop code.
